(19) United States
(12) Patent Application Publication
(10) Pub. No.: US 2002/0039149 A1
(43) Pub. Date: Apr. 4, 2002

(54) System and method for streaming video over a network

(76) Inventor: Eduardo Perez, Austin, TX (US)

Correspondence Address: Robert D. Wasson, SKJERVEN MORRILL MacPHERSON LLP, 28th Floor, Three Embarcadero Center, San Francisco, CA, 94111, US

(21) Appl. No.: 09/966,876

(22) Filed: Sep. 28, 2001

Related U.S. Application Data
(60) Provisional application No. 60/237,404, filed on Oct. 2, 2000.

(51) Int. Cl. H04N 11/02

(52) U.S. Cl. 348/469; 375/240.19

(57) ABSTRACT

A system and method are disclosed for providing streaming video over a network by compressing video data in a cascaded fashion. Initially, the system compresses video data to a first intermediate data file using a first transform. Next, the system compresses the first intermediate data file to a second intermediate data file using a second transform. The second intermediate data file is then compressed to a streaming video data file using a third transform. The streaming video data is then transmitted over the network, such as the Internet, as streaming video data. In one embodiment, the first intermediate data file is an MPEG-2 data file and the second intermediate data file is an unconstrained MPEG-1 data file. The first and second transforms may be carried out in transparent mode.

### Cross Reference to Related Application

This application relates to and claims priority of U.S. Provisional Patent Application No. 60/237,404, entitled “METHOD FOR DELIVERY OF HIGH QUALITY STREAMING VIDEO DATA FILES OVER THE INTERNET,” filed Oct. 2, 2000 by Eduardo Perez, the entire disclosure of which is incorporated herein by reference.

### TECHNICAL FIELD

The present invention relates to video data compression, and more particularly to a system and method for compressing video data for streaming over a network, such as the Internet.

### BACKGROUND

Streaming video is a sequence of “moving images” that are sent in compressed form by a server computer over the Internet to a client computer and displayed at the client computer to a viewer as the moving images arrive. With streaming video, the viewer does not typically have to wait to download a large file before seeing the video. Instead, the server sends the streaming video in a continuous stream and the client computer plays the streaming video as the streaming video arrives. The client computer includes a streaming video player, which is software package that uncompresses the streaming video and sends the uncompressed video data to an associated display device for viewing. The streaming video player can be either an integral part of a web browser or a separate program. The streaming video player may, alternatively, be disposed in a separate housing, such as in a set top box. Streaming video data over a network is widely used on the Internet to deliver video on demand or a video broadcast at a set time.

However, traditional systems and methods for providing streaming video over a data network have been largely unable to effectively transmit high quality video, such video of DVD (Digital Versatile Disk) quality, due, at least in part, to bandwidth limitations. DVD Video files, for example, are typically encoded at about 6 Mbps, which far exceeds the maximum bandwidth of many conventional dial-up and broadband Internet access technologies.

Conventional broadband Internet access is typically achieved using DSL (Digital Subscriber Line), cable modem, and satellite technologies, or the like. These technologies generally provide Internet access to users at bandwidths in the range of about 300 kbps (kilobits per second) to about 1.5 Mbps (Megabits per second). Dial-up Internet access is typically limited to about 56 kbps or less. Ti lines are frequently used to provide Internet access for many businesses and typically provide a bandwidth of about 1.5 Mbps.

One attempt to provide streaming video uses AVI (Audio Video Interleaved) format streaming video. AVI generally interleaves standard waveform audio and digital video frames (bitmaps) to provide reduced animation, resolution, and quality. In addition, the AVI format uses lossy compression techniques that are generally inefficient, do not significantly conserve storage space or bandwidth, and are typically limited to under an hour of video.

A need exists, therefore, for a low cost system and method for producing high quality video streams that can be transmitted over conventional Internet access services. An additional need exists to provide a system and method for producing DVD and broadcasting quality streaming video that may be transmitted over the Internet as streaming video data at data rates supportable by common Internet access services.

### SUMMARY

The present invention provides a system and method for compressing video data in a cascaded fashion to permit high quality video data to be streamed over a network using bandwidths typical of residential broadband and business Internet access services.

According to one embodiment, the present system and method initially compress video data to a first intermediate data file using a first transform. The first intermediate data file may comprise an MPEG-2 data file encoded at a data rate of more than about 5 Mbps. Next, the present system and method compress the first intermediate data file to a second intermediate data file using a second transform. The second intermediate data file may comprise an unconstrained MPEG-1 data file. The conversion from the first intermediate data file to the second intermediate data file may de-interleave and compress the first intermediate data file by a ratio of about 2:1 or more. The second intermediate data file is then compressed and converted to a streaming video data file using a third transform. The conversion from the second intermediate data file to the streaming video data file may compress the second intermediate data file by a ratio of about 2:1 or more.

The cascading first, second, and third transforms gradually compress the video data without significant loss of information. In one embodiment, the first and second transforms compress the video data in transparent mode. The third transform operates in transparent mode or substantially in transparent mode. Performing the first and second transforms in transparent mode significantly limits the propagation of error through the compression sequence.

Additionally, using unconstrained MPEG as an intermediate data file format permits the quality of the compressed video data in the unconstrained MPEG data file to be optimized without being limited by the constrained MPEG parameters, such as encoding rate and form factor, that are otherwise necessary for purposes of compatibility and interoperability.

After the video data has been compressed and converted to a streaming video data file, a server then transmits the streaming video data file over a network, such as the Internet, to a client computer coupled to the network. The client computer then receives streaming video data file and causes the same to be displayed on an associated display device.

Additional features and benefits of the present system and method will be apparent to those skilled in the art from the following detailed description and the accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 illustrates an environment in which a server, according to an embodiment of the present invention, may operate.

FIG. 2 illustrates a FIG. 1 server having a cascading compression engine, according to an embodiment of the present invention.

FIG. 3 illustrates a FIG. 1 client having a streaming video player, according to an embodiment of the present invention.

FIG. 4 is a data flow diagram illustrating data flow, according to an embodiment of the present invention.

FIG. 5 is a flow diagram illustrating an exemplary method of operating the cascading compression engine, according to an embodiment of the present invention.

FIG. 6 illustrates a FIG. 2 video input device according to one embodiment of the present invention.

### DETAILED DESCRIPTION

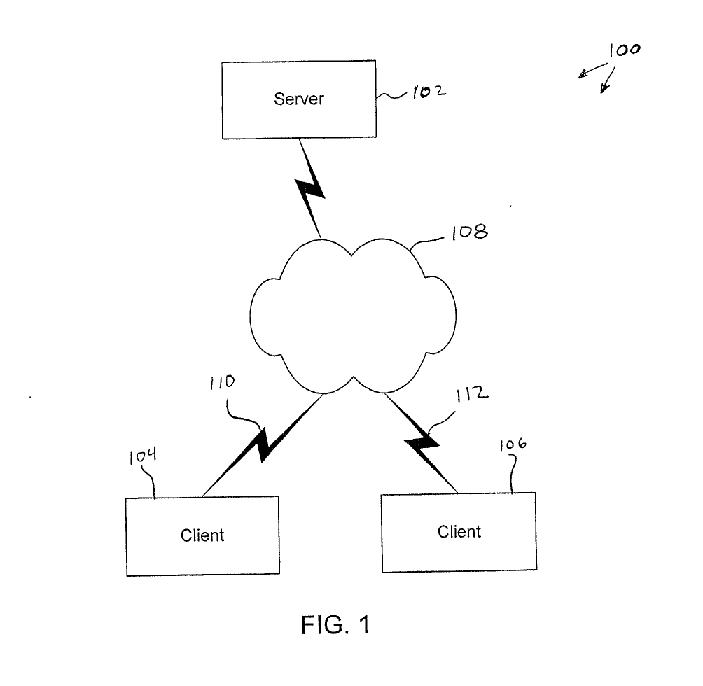

Embodiments of the present invention and their advantages are best understood by referring to FIGS. 1-6 of the drawings. Like numerals are used for like and corresponding features of the various drawings.

Definitions

Transparent mode: A mode of compressing a video data file into a compressed video data file such that, when played, a human eye is incapable of distinguishing between the video data and the compressed video data file.

Constrained MPEG file: An MPEG file wherein all parameters are within the constrained ranges set forth in the associated MPEG standard.

Unconstrained MPEG file: An MPEG file wherein all parameters are not within the constrained ranges set forth in the associated MPEG standard.

Environment

FIG. 1 illustrates an exemplary environment 100 in which a server 102, such as a video server, may operate. In this exemplary environment 100, the server 102 is coupled to a number of client computers 104, 106 via a network 108.

In general, the server 102 delivers streaming video data to one or more of the client computers 104, 106 over the network 108. For example, a user at one of the client computers 104, 106 may transmit a request to the server 102 over the network 108 for delivery of streaming video data. The server 102, in response, may commence delivery of streaming video data over the network 108 to the user at the associated one of the client computers 104, 106.

The functionality of the server 102 can be performed by any one or more suitable processors, such as mainframes, file servers, workstations, or other suitable data processing facilities running appropriate software. The server 102 may operate under the control of any suitable operating system such as MS-DOS, MacINTOSH OS, WINDOWS NT, WINDOWS 95/98/2000, OS/2, UNIX, SOLARIS, or the like.

In general, the server 102 may maintain, and serve a website, which serves as a repository for streaming video data. In addition to streaming video, the website can store written text, images, graphics, music, voice, or the like. Pursuant to one embodiment, the streaming video data at the server 102 comprises e-learning or entertainment content to permit users at client computers 104, 106 to access such data and view the same at the client computers 104, 106.

Pursuant to one embodiment, the network 108 comprises the Internet. In general, the Internet is an interconnection of computers located throughout the world and exchanging information according to Transmission Control Protocol/Internet Protocol (TCP/IP), Internetwork Packet eXchange/Sequence Packet exchange (IPX/SPX), AppleTalk, or other suitable protocol. The Internet generally supports the distributed application known as the “World Wide Web.” Web servers maintain websites, each comprising one or more web pages at which information, such as streaming video data, is made available for viewing. Each website or web page can be identified by a respective uniform resource locator (URL) and may be supported by documents formatted in any suitable language, such as, for example, hypertext markup language (HTML), extended markup language (XML), or standard generalized markup language (SGML). The Internet permits interactive communication between users and the website.

In one embodiment, the client computers 104 and 106 communicate with other devices coupled to the network 108 through high speed (greater than about 300 kbps) links 110 and 112, respectively. Each of the links 110 and 112 may comprise a DSL (Digital Subscriber Line) link, a cable modem link, a satellite link, a T1 link, or the like. Thus, the client computers 104 and 106 may exchange information with other devices coupled to the network 108 via the associated links 104 and 106 at data rates greater than about 300 kbps and, in many instances, at data rates of 1 Mbps or greater. optionally, the links 110, 112 comprise dial-up Internet access links, each having a bandwidth of about 56 kbps or less.

Each client computer 104, 106 can be operating a suitable “web browser” program. A web browser is a computer program that allows the exchange of information with the World Wide Web. A variety of web browsers are available, such as NETSCAPE NAVIGATOR from Netscape Communications Corp., INTERNET EXPLORER from Microsoft Corporation, and others that allow convenient access and navigation of the Internet. Information may be communicated from the server 102 to the client computers 104, 106 using a suitable protocol, such as, for example, HyperText Transfer Protocol (HTTP) or File Transfer Protocol (FTP). Each client computer 104, 106 may operate under the control of any suitable operating system such as MS-DOS, MacINTOSH OS, WINDOWS 95/98/2000/ME, UNIX, or the like.

The server 102 stores video data in a streaming video data format and transmits the same over the network 108 and links 110 and 112 to client computers 110 and 112, respectively, at data rates equal to or less than the maximum supported by the links 110 and 112. The streaming video data may be of any suitable streaming video data format, such as ASF (Advanced Streaming Format), WMV (Windows Media Video), RM (Real Media), or the like.

In one embodiment, the streaming video data is at least of DVD-Video (Digital Versatile Disk Video) quality and is encoded at a data rate of 1-1.5 Mbps or less. Thus, the server 102 may deliver streaming video of at least DVD-Video quality to the client computers 104, 106 over the network 108 without exceeding maximum bandwidth limitations of the links 110, 112, respectively.

In another embodiment, the streaming video is of HDTV (High Definition TV) quality and is encoded at bit rates of about 6 Mbps or less. Pursuant to this embodiment, the links 110 and 112 have maximum data rates of about 6 Mbps or greater.

As discussed in more detail below, the streaming video data comprises video data that has undergone a plurality of data compression transforms in cascaded fashion. The data compression transforms may be conducted at the server 102. Optionally, the data compression transforms may be conducted at another computer and transferred to the server 102 for delivery to the client computers 104, 106 over the network 108 and links 110, 112, respectively.

Computer Hardware

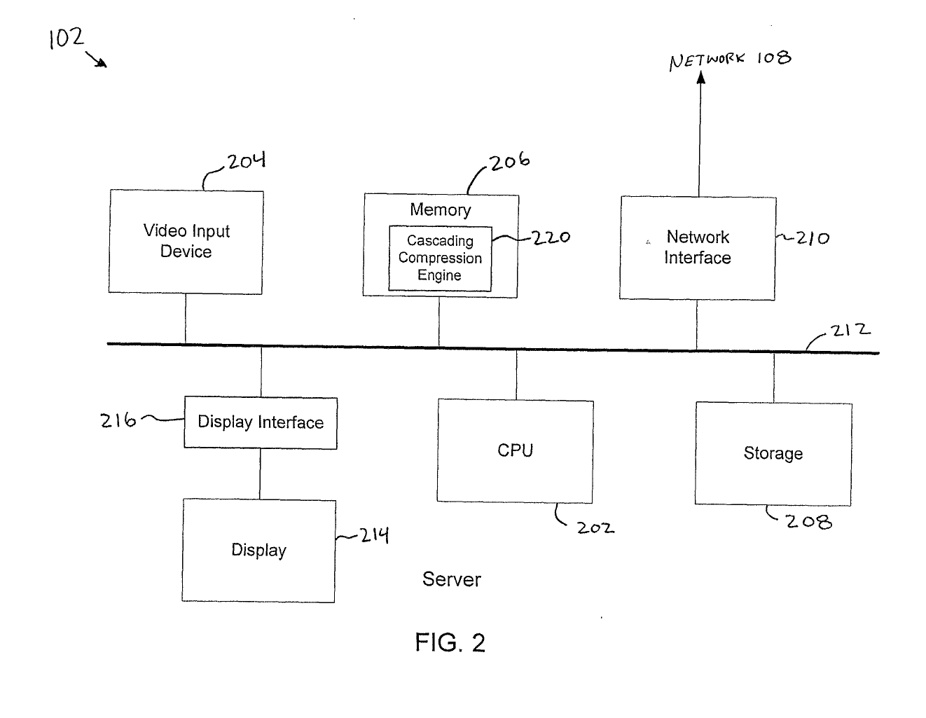

FIG. 2 illustrates details of the server 102, according to an embodiment of the present invention. The server 102 is a video server for creating streaming video data and delivering streaming video data over the network 108 (FIG. 1). The server 102 includes a central processing unit 202, a video input device 204, a memory 206, a storage device 208, and a network interface 210, all coupled by at least one data bus 212 to permit passage of data between these devices. Optionally, the server 102 may also include a display 214 coupled to the bus 212 by a display interface 216.

The central processing unit 202 may comprise any of a variety of data processor devices, such as a PENTIUM III data processor available from Intel Corporation or one or more of a variety of data processors suitable for use in servers, such as Internet video servers.

The video input device 204 may comprise any of a variety of video input devices that are able to output video data as an MPEG-2 data file. For example, the video input device 204 may comprise a digital video recorder, a DVD-Video disk and drive, a video camera, a Beta SP or S-VHS videocassette and videocassette player, a video capture card, a combination of the foregoing, or the like.

In one embodiment, the video input device 204 outputs an unconstrained MPEG-2 data file, which is not limited by the constraint parameters, such as bit rate, of constrained MPEG-2. Thus, the video input device 204 receives video data and converts the video data into an intermediate data file, such as an unconstrained MPEG-2 data file, using an MPEG-2 compression transform to compress the video data in transparent mode. Optionally, the video input device 204 may output a constrained MPEG-2 data file.

The memory 206 may comprise non-volatile memory or a combination of volatile and non-volatile memory and includes a cascading compression engine 220. As discussed in more detail below, the cascading compression engine 220 receives a first intermediate data file from the video input device, such as either a constrained or an unconstrained MPEG-2 data file, and converts the first intermediate data file into a second intermediate data file using a compression transform. In one embodiment, this compression transform is an MPEG-2 to unconstrained MPEG-1 transform and converts the first intermediate data file from MPEG-2 format to a second intermediate data file in unconstrained MPEG-1 format in transparent mode.

MPEG-1 and MPEG-2 standards and compression techniques are well-known. Details regarding MPEG-1 and MPEG-2 standards and compression techniques are set forth in the following International Organization for Standardization publications: ISO/IEC 11172 (MPEG-1) and ISO/IEC 13818 (MPEG-2), both of which are incorporated herein by reference. Additional details regarding MPEG-1 and MPEG-2 standards and compression techniques are found in MPEG Video Compression Standard, by Mitchell, et al., ISBN 0412-08771 (Chapman & Hall, 1996), the disclosure of which is incorporated herein by reference.

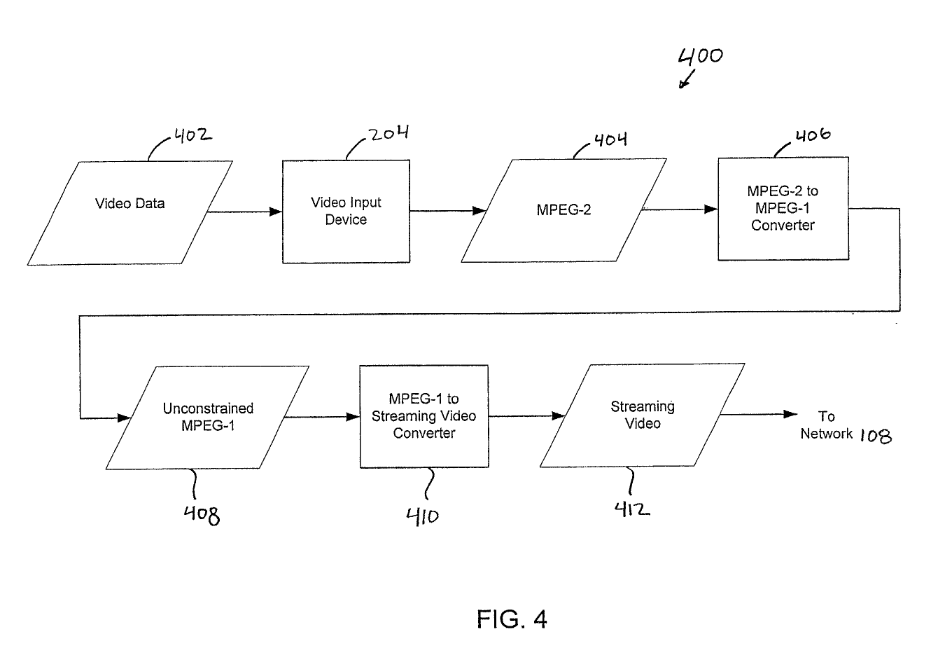

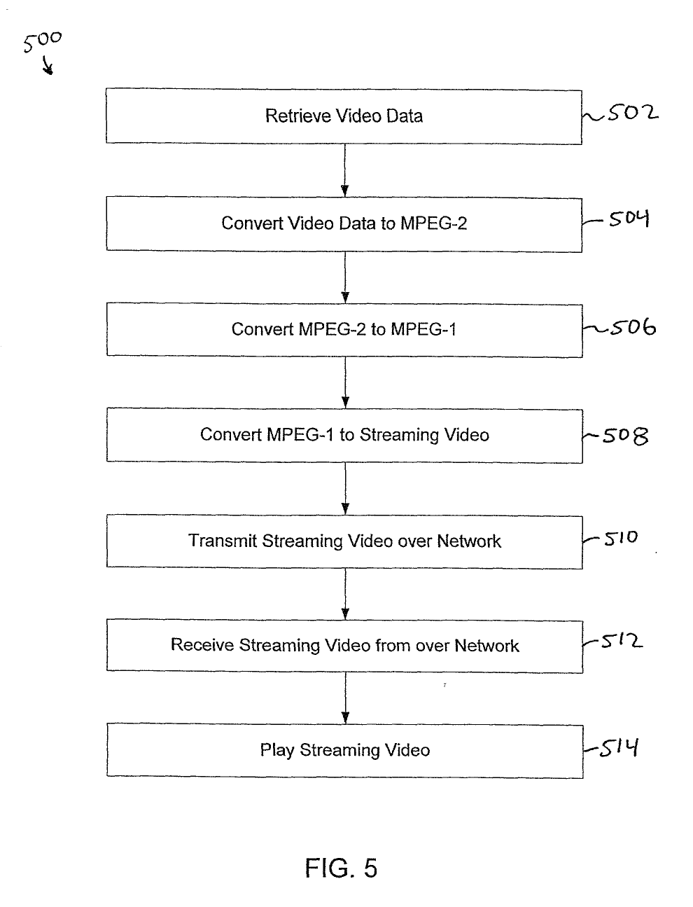

The cascading compression engine 220 then converts the second intermediate data file into a streaming video data file. In one embodiment, the cascading compression engine 220 converts the second intermediate data file from an unconstrained MPEG-1 format to a streaming video data file having in a format such as ASF, WMV, or RM. Additional details regarding the cascading compression engine 220 are illustrated in FIGS. 4 and 5 and are discussed below.

The storage device 208 may comprise a non-volatile memory having sufficient storage space to store the first and second intermediate data files and the streaming video data file described above.

The network interface 210 serves to interface the server 102 with the network 108 (FIG. 1) for permitting the exchange of data between the server 102 and the network 108. The network interface 210 may comprise an IP (Internet Protocol) interface, a modem, or the like. The server 102 uses the network interface 210 to transmit the streaming video data file from the server 102 over the network 108 to one or more of the client computers 104, 106 (FIG. 1).

Optionally, the server 102 may include the display 214 coupled to the data bus 212 by the display interface 214. The display 214 may comprise a CRT (Cathode Ray Tube), a liquid crystal device, or the like. In embodiments where the display 214 comprises a computer monitor, the display interface 216 may comprise a video card for interfacing the display 214 with the data bus 212. In embodiments where the display comprises a television set, the display interface 216 may comprise a VGA-NTSC scan converter. The display 214 may be used to display the MPEG-2 data file, the unconstrained MPEG-1 data file, the streaming data file, or the like.

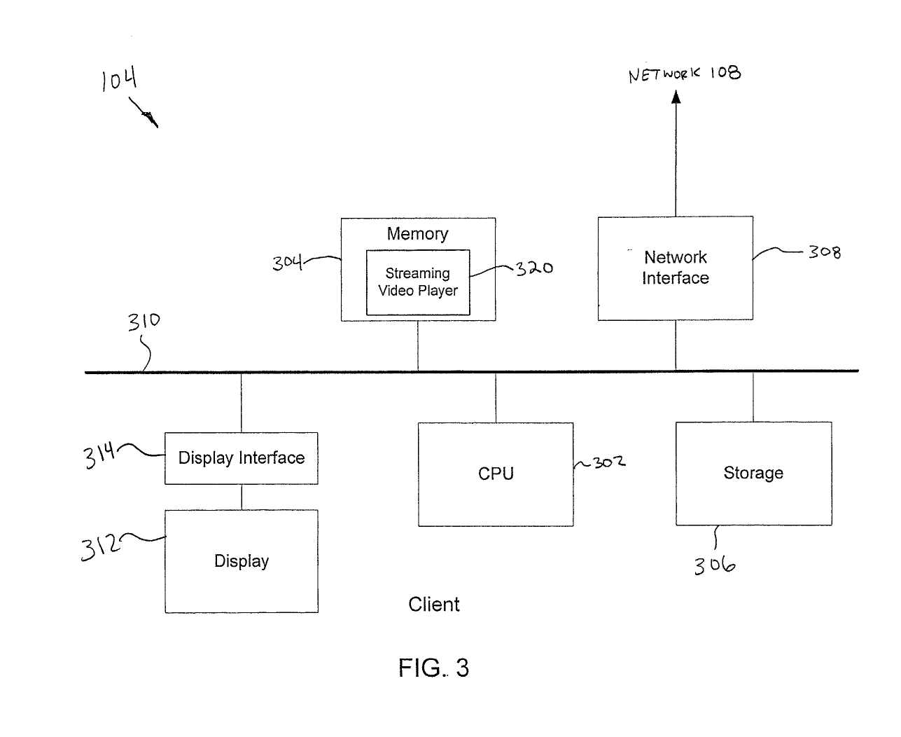

FIG. 3 illustrates details of the client computer 104 (FIG. 1). The client computer 104 receives streaming video data from the server 102 over the network 108 (FIG. 1). The client computer 104 is shown as having a central processing unit 302, a memory 304, a storage device 306, and a network interface 308, all coupled by at least one data bus 310 to permit passage of data between these devices. Optionally, the client computer 104 may also include a display 312 coupled to the data bus 310 by a display interface 314.

The central processing unit 302 may comprise any of a variety of data processor devices, such as a PENTIUM III data processor available from Intel Corporation or one or more of a variety of data processors suitable for use in personal computers.

The memory 304 may comprise non-volatile memory or a combination of volatile and non-volatile memory and includes a streaming video player 320. As discussed in more detail below, the streaming video player 320 receives streaming video data from the server 102 (FIG. 1) from over the network 108 and plays, or displays, the streaming video data on the display 312. The streaming video player 320 may comprise WINDOWS MEDIA PLAYER streaming media player, available from Microsoft Corporation or REALPLAYER streaming media player, available from RealNetworks, Inc., or the like. Moreover, the streaming video player 320 may comprise an integral part of a web browser or may comprise a distinct program.

The storage device 306 may comprise a non-volatile memory device.

The network interface 308 operates to interface the client computer 104 with the network 108 (FIG. 1) for permitting the exchange of data between the client 104 and the network 108. The network interface 308 may comprise a network interface card, a modem, or the like for interfacing the client computer 104 with the network 108 via the associated link 110 (FIG. 1).

Optionally, the client computer 104 may include a display 312 coupled to the data bus 310 by a display interface 314. The display 312 may be similar to the display 214 described above and the display interface 314 may be similar to the display interface 216 described above.

The client computer 106 may be configured in a manner identical to that of the client computer 104. Accordingly, no further description of the client computer 106 is necessary.

Cascading Compression

FIG. 4 is a data flow diagram 400 illustrating one embodiment of the present invention. FIG. 5 is a flow chart 500 illustrating one embodiment of a method associated with the FIG. 4 data flow diagram. FIGS. 4 and 5 illustrate details of the operation of the cascading compression engine 220 (FIG. 2).

Referring now to FIGS. 4 and 5, the method begins by retrieving video data 402 (FIG. 4) pursuant to block 502 (FIG. 5). The video data 402 may comprise 4:4:4 video, which is uncompressed raw video with no sub-sampling and where Y, Cb, and Cr video components are sampled equally. The video data 402 may be retrieved by the video input device 204 (FIG. 2).

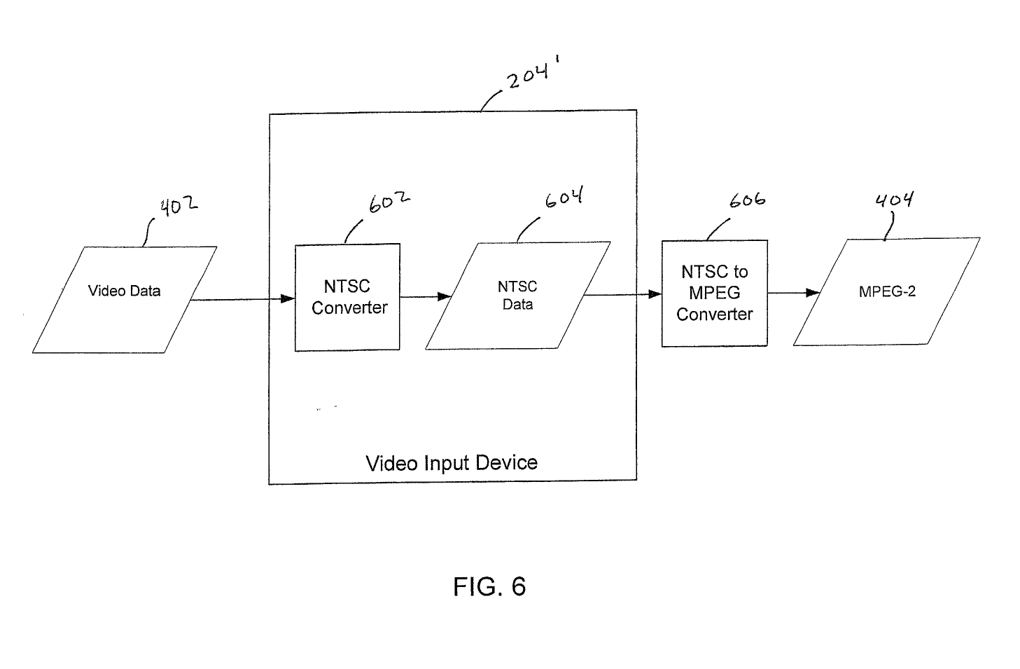

As shown in FIG. 6, the video input device 204 (FIG. 4) may comprise, according to one embodiment, a video camera 204′, which receives the video data 402 and outputs an NTSC (National Television Systems Committee) data 604 to an NTSC to MPEG-2 converter 606. The NTSC to MPEG-2 converter 606 may comprise a video capture card, which receives the NTSC format video data 604 and converts the NTSC format video data 604 to the MPEG-2 data file 404, pursuant to block 504 (FIG. 5).

In converting the video data 402 into NTSC format video data 604, the video camera 204′ compresses the video data 402 by about a 3:2 conversion. In converting the NTSC format video data 604 into the MPEG-2 data file 404, the NTSC to MPEG converter 606 compresses the NTSC format video data 604 by about a 30:1 conversion.

The video camera 204′ may comprise any of a variety of conventional video cameras, which record raw video data and convert the same to NTSC data, which may then be captured by the NTSC to MPEG converter 606 and converted to an MPEG2 data file. For example, the video camera 204′ may comprise a conventional DV (Digital Video) camera.

In another embodiment, the video input device 204 (FIGS. 2 and 4) comprises a DVD-Video disk and disk drive (not shown). Pursuant to this embodiment, the DVD-Video disk has video data stored thereon as one or more MPEG-2 files and outputs the MPEG-2 data file 404 (FIG. 4). In one embodiment, the MPEG-2 data file is encoded at a data rate in the range of about 4-6 Mbps. In another embodiment, the MPEG-2 data file 404 is encoded at a data rate in the range of 9-12 Mbps. The MPEG-2 data file 404 may be of broadcast or DVD film quality, for example.

In yet another embodiment, the video input device 204 may comprise an MPEG-2 video capture card coupled to a Beta SP or S-VHS videocassette and videocassette player (not shown). Pursuant to this embodiment, the videocassette has high-quality video data stored thereon, which is captured by the video capture card. The video capture card captures the video data stored on the videocassette and converts the same to an MPEG-2 data file, such as the MPEG-2 data file 404, pursuant to block 504 (FIG. 5).

Next, an MPEG-2 to MPEG-1 converter 406 converts the MPEG-2 data file 404 to an unconstrained MPEG-1 data file 408 in transparent mode, pursuant to block 506 (FIG. 5). In converting the MPEG-2 data file 404 to an unconstrained MPEG-1 data file 408 the MPEG-2 to MPEG-1 converter 406 compresses the MPEG-2 data file 404 by a ratio in the range of about 1.5:1 to 6:1, depending on the application. The unconstrained MPEG-1 data file 408 is in unconstrained format, meaning that the MPEG-1 data file is not compliant with all the MPEG-1 constraints. In addition, the MPEG-2 to MPEG-1 converter 406 converts the MPEG-2 data file 404 to the unconstrained MPEG-1 data file 408 in transparent mode.

In one embodiment, the MPEG-2 to MPEG-1 converter 406 converts the MPEG-2 data file 404 to the MPEG-1 data file 408 at about 6 Mbps at 30 frames per second for broadcast quality and 24 frames per second for film. In addition, if the MPEG-2 data file 404 comprises interlaced video data, the MPEG-2 to MPEG-1 converter 406 de-interlaces the interlaced video data.

The MPEG-2 to MPEG-1 converter 406 may comprise any of a variety of conventional MPEG-2 to MPEG-1 converter software packages such as FLASKMPEG, MPEG-1 ENCODER by Panasonic, DVD2MPEG, or the like. The MPEG-2 to MPEG-1 converter comprises a part of the cascading compression engine 220 (FIG. 2).

Next, pursuant to block 508 (FIG. 5), an MPEG-1 to streaming video converter 410 (FIG. 4) converts the unconstrained MPEG-1 data file 408 to streaming video 412. In converting the unconstrained MPEG-1 data file 408 to streaming video 412 the unconstrained MPEG-1 to streaming video converter 410 may compress the unconstrained MPEG-1 data file 408 at a ratio in the range of about 2:1 to 3:1 for transparent mode and up to about 40:1 for non-transparent mode. The streaming video 412 may comprise a streaming video format such as ASF, WMV, RM, or other suitable streaming video format. The streaming video 412 may be stored at the server 102 (FIG. 2) at the storage device 208 (FIG. 2).

The MPEG-1 to streaming video converter 410 may comprise any of a variety of suitable MPEG-1 to streaming video converters, such as WINDOWS MEDIA from Microsoft Corporation, REAL PRODUCER from Realnetworks, Inc., STREAM ANYWHERE, from Sonic Foundry, Inc. The MPEG-1 to streaming video converter 410 may comprise a part of the cascading compression engine 220 (FIG. 2).

Next, pursuant to block 510 (FIG. 5), the server 102 (FIG. 1) transmits the streaming video 412 from the server 102 over the network 108 to at least one of the client computers 104, 106 (FIG. 1). In one embodiment, the server 102 receives a request from one of the client computers 104, 106 for transmission of the streaming video 412. The server 102, in response, commences transmission of the streaming video 412 over the network 108 via the network interface 210 (FIG. 2) of the server 102. In one embodiment, the server 102 transmits the streaming video 412 at a data rate less than about 1.5 Mbps. In another embodiment, the server 102 transmits the streaming video 412 at a data rate less than about 6 Mbps.

One or more of the client computers 104, 106 (FIG. 1) then receives the streaming video 412 (FIG. 4) as transmitted over the network 108 from the server 102, pursuant to block 512 (FIG. 5). The client computers 104, 106 may receive the streaming video 412 from over the network 108 via an associated link 110, 112 (FIG. 1) and network interface 308 (FIG. 3). In one embodiment, the client computers 104, 106 receive the streaming video 412 at a data rate less than about 1.5 Mbps. In another embodiment, the client computers 104, 106 receive the streaming video 412 at a data rate of about 6 Mbps or less.

Lastly, the streaming video player 320 (FIG. 3) plays the received streaming video 412 at the client computer 104 (FIG. 3), at which the streaming video 412 is received, pursuant to block 514 (FIG. 5). The streaming video player 320 causes the streaming video 414, as received, to be displayed at the display 312 (FIG. 1). Optionally, the client computer 104 may store the streaming video 412, as received, as a data file at the storage device 306 for later playing.

While particular exemplary embodiments have been shown and described, it will be apparent to practitioners that various changes and modifications may be made without departing from our invention in its broader aspects. Accordingly, the appended claims encompass all such changes and modifications as fall within the scope of this invention.

What is claimed is:

1. A method for creating streaming video data, the method comprising:
compressing video data to a first intermediate data file using a first transform;
compressing the first intermediate data file to a second intermediate data file using a second transform;
compressing the second intermediate data file to a streaming video data file using a third transform.

2. The method according to claim 1, wherein the first intermediate data file comprises an MPEG-2 data file.

3. The method according to claim 1, wherein the second intermediate data file comprises an unconstrained MPEG-1 data file.

4. The method according to claim 1, wherein the video data further comprises NTSC format video data.

5. The method according to claim 1, wherein the first intermediate data file further comprises an MPEG-2 data file and the second intermediate data file further comprises an unconstrained MPEG-1 data file, the compressing the first intermediate data file to a second intermediate data file further comprising converting the MPEG-2 data file to the unconstrained MPEG-1 data file.

6. The method according to claim 1, further comprising de-interlacing the first intermediate data file using the first transform.

7. The method according to claim 1, wherein the first intermediate data file is encoded at rate of 5 Mbps or more.

8. The method according to claim 1, wherein the streaming data file is encoded at a rate of 1.5 Mbps or less.

9. The method according to claim 1, further comprising transmitting the streaming data file over a network.

10. The method according to claim 1, wherein the first intermediate data is encoded at about 30 frames per second land wherein the compressing the first intermediate data file to a second intermediate data file using a second transform further includes encoding the second intermediate data file at about 30 frames per second or less.

11. The method according to claim 1, wherein the compressing the first intermediate data file to a second intermediate data file using a second transform is performed in transparent mode.

12. A method for creating streaming video data, the method comprising:
converting video data to an MPEG-2 data file using a first transform;
converting the MPEG-2 data file to an unconstrained MPEG-1 data file using a second transform;
converting the MPEG-1 data file to a streaming video data file using a third transform.

13. The method according to claim 12, wherein the converting the MPEG-2 data file to an unconstrained MPEG-1 data file using a second transform is performed in transparent mode.

14. The method according to claim 12, wherein the MPEG-2 data file is encoded at a rate of 5 Mbps or greater.

15. The method according to claim 12, wherein the video data further comprises NTSC format video data.

16. The method according to claim 12, further comprising de-interlacing the first intermediate data file using the first transform.

17. The method according to claim 12, wherein the converting the first intermediate data file to a second intermediate data file using a second transform is performed in transparent mode.

18. The method according to claim 12, wherein the first intermediate data is encoded at about 30 frames per second and wherein the converting the first intermediate data file to a second intermediate data file using a second transform further includes encoding the second intermediate data file at about 30 frames per second or less.

19. A method for creating streaming video data, the method comprising:
converting an MPEG-2 data file to an unconstrained MPEG-1 data file in transparent mode using a first transform;
converting the unconstrained MPEG-1 data file to a streaming video data file using a second transform.

20. A computer-readable medium comprising program instructions for creating streaming video data, by performing the steps of:
converting an MPEG-2 data file to an unconstrained MPEG-1 data file in transparent mode using a first transform;
converting the unconstrained MPEG-1 data file to a streaming video data file using a second transform.
